(19) United States
(12) Patent Application Publication
(10) Pub. No.: US 2012/0262615 A1
(43) Pub. Date: Oct. 18, 2012

(54) Optical system consisting of digital optical attachment unit and basic day-vision optical device

(75) Inventor: Leonid Gaber, So. San Francisco, CA (US)

(73) Assignee: AMERICAN TECHNOLOGIES NETWORK CORPORATION, INC.

(21) Appl. No.: 13/066,343

(22) Filed: Apr. 13, 2011

(51) Int. Cl. H04N 5/335

(52) U.S. Cl. 348/311; 348/E05.091

(57) ABSTRACT

An optical system consisting of a basic day-vision optical device, such as an optical sight, and a digital optical attachment unit, such as a CCD module, a thermovisor, a range finder, or the like. A distinguishing feature of the system is the optical attachment unit which does not have an eyepiece and contains a power supply unit for the basic day-vision optical device. On the other hand, the basic day-vision optical device does not have a power supply unit but among other things contains a beam splitter and an electronic microdisplay. When the digital optical attachment unit is attached to the basic day-vision optical device and electrically connected to the latter, the electronic microdisplay receives a target image from the digital attachment unit and through the beam splitter a target and reticle image obtained by the basic day-vision device. As a result, a viewer can see an enhanced fused image of both image components reproduced on the electronic microdisplay.

### FIELD OF THE INVENTION

The present invention relates to an optical fusion technique, and, more specifically, to an optical system with automatic mixing of digital optical attachment images with images of a basic day-vision optical sight. The optical sight system of the invention is intended for use on a firearm as well as on spotting scopes, binoculars, etc.

### BACKGROUND OF THE INVENTION

Known in the art is a wide variety of optical sights, which, according to one variety of classifications, is categorized according to three ranges of operational wavelength: (1) day vision; (2) night vision; and (3) thermal vision. Day-vision optical sights operate in the wavelength range of approximately 400 nm to 700 nm. Night-vision optical sights operate in the wavelength range of near infrared light to approximately 1.7 nm. Thermal-vision sights operate in the middle infrared wavelength range to 13 μm.

Typically, day-vision optical sights are used with firearms such as guns or rifles to allow the user to more clearly see a target. Conventional optical sights include a series of lenses that magnify an image and are provided with a reticle that allows the user to align the magnified target relative to the barrel of the firearm. Proper alignment of the optical sight with the barrel of the firearm allows the user to align the barrel of the firearm and, thus, to align the projectile fired therefrom with the target by properly aligning a magnified image of the target with the reticle pattern of the optical sight. A great variety of various modifications exists for day-vision optical sights, such as sights with reticle illumination, red-dot sights, etc.

An example of a conventional day-vision optical sight is disclosed in U.S. Pat. No. 7,411,750 issued on Aug. 12, 2008 to S. Pai. The optical sight includes an outer barrel having opposite ends; ocular and objective lens units mounted respectively to the ends of the outer barrel; a magnification unit disposed tiltably in the outer barrel and extending between the ocular and objective lens units; an adjustment unit mounted on the outer barrel that operates independently and respectively to adjust the position of the magnification unit inside the outer barrel in first and second directions that are perpendicular to each other.

A typical night-vision sight uses an objective a lens of maximum size for maximum light-gathering capability. After passing through the objective lens, light passes through a focusing assembly that varies the distance of light traveling between lenses within the sight by moving either the focal-length adjustment lens, with respect to the objective lens, or a mirror within the night-vision device along the axis that changes the length of the light path. The light is therefore brought into sharp focus on the photosensitive surface of the image intensifier. In a night-vision sight, a photocathode having electrical current flowing therethrough, which forms the photosensitive surface of the image intensifier, converts the optical image into an electronic image that is transmitted through electron flow. The electrons accelerate through the image intensifier and remain focused because of the proximity of surfaces within the image-intensifier tube. Acceleration of electrons, combined with a microchannel electron-multiplying plate, results in intensification of the original image. When the electrons reach the screen, the electronic image is converted to an optical image. The final, amplified visible image is displayed to the user or to other optical devices within the night sight.

An example of a night-vision sight is disclosed in U.S. Pat. No. 6,456,497 issued on Sep. 24, 2002 to G. Palmer. This patent describes a night-vision binocular assembly that includes at least one objective lens assembly, an image-intensifier tube, a collimator lens assembly, and a diopter cell assembly encased in easy-to-assemble waterproof housing. The objective lens assembly, image-intensifier tube, collimator lens assembly, and diopter cell assembly are supported by a common base structure within the housing. The device is provided with button controls to operate and adjust the night-vision binocular assembly. The button controls are placed on a common circuit board, which is affixed to the interior of the binocular housing.

Known in the art is a night-vision sight, which is installed on the soldier's helmet and which for convenience of use under combat conditions and for preventing operation of a light source when the sight is not in use is provided with automatic switching, depending on the position of the sight on the helmet. Such a device is disclosed, e.g., in U.S. Pat. No. 6,087,660 issued on Jul. 11, 2000 to T. Morris, et al. The night-vision device includes a control circuit having an acceleration-responsive switch. When the night-vision device is in the horizontal position, the acceleration-responsive switch enables a circuit that allows voltage to be applied to an image-intensifier tube of the night-vision device so that night vision is provided. On the other hand, when the device is flipped up to a stowed position on the helmet, which allows the user of the device unobstructed natural vision, the acceleration-responsive switch senses the changed orientation of the gravitational acceleration vector and turns off the image-intensifier tube as well as other light-emitting sources of the night-vision device. The acceleration-responsive switch controls operation of the voltage step-up circuit, which allows the night-vision device to operate with a single one-and-one-half-volt battery cell and which also ensures that all sources of light emissions from the night-vision device are turned off when the acceleration-responsive switch is turned off.

There exist a variety of image-fusion optical sights in which various modes of image reproduction are used in combination simultaneously or alternatively.

For example, U.S. Patent Application Publication 2007/0035824 published Feb. 15, 2007 (inventor R. Scholtz) discloses a sighted device operable in visible-wavelength or electro-optical/visible-wavelength sighting modes. The device has a sight that includes an objective lens lying on the optical axis of the sight so that an input beam is coincident with the optical axis; an eyepiece lens lying on the optical axis; an imaging detector having a detector output signal; a signal processor that receives the detector output signal from the imaging detector, modifies the detector output signal, and has a processor output signal; and a video display projector that receives the processor output signal and has a video display projector output. An optical beam splitter lies on the optical axis. The beam splitter allows a first split subbeam of the input beam to pass to the eyepiece lens and reflects a second split subbeam of the input beam to the imaging detector. An optical mixer mixes the first split subbeam and the video display projector output before the first split subbeam passes through the eyepiece lens. According to one aspect of the invention disclosed in U.S. Patent Application Publication 2007/0035824, the imaging detector of the sight may include a silicon charge-coupled device (CCD), a complementary metal oxide semiconductor (CMOS), an intensifier fiber coupled to a CCD, and an InGaAs array. The imaging detector may be located at the objective primary focus.

Another example of a switchable optical sight is a self-contained day/night optical sight disclosed in U.S. Pat. No. 6,608,298 issued on Aug. 19, 2003 to L. Gaber. The device has a sealed sight housing permanently attached to the weapon or to another object and containing an objective lens and an eyepiece lens installed on a common optical path at a spaced distance between the two lenses. The same sealed housing pivotally supports the night-vision unit, such as an image-intensifier tube, which can be turned in the plane that contains the optical axis of the sight between the position offset from the aforementioned common optical axis and the position coincident with the optical axis. Since both night-vision and day-vision optics are located in a sealed housing, the lenses are protected from contamination and fogging. The use of a single optical path makes it possible to reduce the weight of the system. Rotation of the night-vision unit to the working position is interlocked with the day-vision optics so that switching of the sight to night-vision conditions automatically shifts the daytime optics back for the distance required to match both optics.

A relatively new trend in the field of optical sight is the use of night-vision sights operating on the principle of thermal vision. Such devices are commercially produced, e.g., by Irvine Sensors Corporation (e.g., Miniaturized Low Power Thermal Viewers and Miniature Thermal Imager, Models MTI 3500 320×240 and MTI 6000 640×480).

Another new trend in the field of optical sights is the use of sights with images of targets reproduced by image fusion. In computer vision, multisensor image fusion is defined as the process of combining relevant information from two or more images into a single image. The resulting image is more informative than any of the input images.

An example of a fused thermal and night scope is disclosed in U.S. Pat. No. 7,319,557 issued on Jan. 15, 2008 to A. Tai. The device includes an optical gun sight, a thermal sight, and a beam combiner. The optical sight generates a direct-view image of an aiming point or reticle superimposed on a target scene. The thermal sight generates a monochromic thermal image of the target scene. The combiner is positioned behind the 1× nonmagnified optical sight and the thermal sight and in front of the exit pupil of the thermal sight. The combiner is positioned directly behind the intermediate image plane of the magnified optical sight between the objective lens and the eyepiece. The combiner passes the direct-view image and reflects the thermal image to the exit pupil to fuse the thermal image onto the direct-view image for viewing by the user at the exit pupil as a combined thermal and direct-view optical image of the target scene together with the aiming reticle.

However, the optical gun sight projects onto the common screen of the display device a direct optical day-vision image onto which a thermogram of the thermal sight is imposed. It is understood that the aforementioned beam combiner cannot function as an image mixer because the thermogram cannot present a meaningful image during the day and cannot reproduce a day-vision image during the night. Therefore, a viewer will see either a day-vision image or a thermogram.

U.S. patent application Ser. No. 12/804,591 filed by Leonid Gaber on Jul. 26, 2010 discloses an optical sight system that comprises the combination of a thermal scope with a CCD visible-range attachment connectable to the thermal scope with a quick-release connector. The system is equipped with a device for automatic interposition of the digital visible image of the CCD visible-range attachment onto the digital thermographic image when the attachment is electrically and mechanically connected to the thermal scope. The CCD is a lightweight device that does not have a screen and that easily attaches to the thermal scope by means of the quick-release connector. When the attachment is connected to the basic thermoscope system, both digital images are observed on the screen of the thermal-scope display. Such constant reproduction of both day-vision visual digital image and thermographic night image on the common screen of the thermal-scope display is especially important for combat conditions when a soldier may not have time to manually switch observation conditions. The disadvantage of this system is that the basis of the system is a thermal scope rather than a day-vision scope.

### SUMMARY OF THE INVENTION

The invention provides an optical system with automatic fusion of attachment images with images of a basic day-vision optical sight. The system consists of a basic day-vision optical unit, e.g., a day-vision optical sight, a spotting scope, a binocular, or the like, and a digital optical attachment unit such as a CCD module, thermovisor, or range finder. The basic day-vision optical sight comprises a housing that contains an objective lens on one end, an eyepiece on the other end, and a Pechan prism with reticle and beam-splitter prism located on the optical axis of the day-vision optical sight between the objective lens and the eyepiece. In the system of the invention the basic day-vision optical sight does not need and does not have a power supply since, as described below, power is provided from the digital optical attachment unit only when the optical attachment unit is mounted on the basic day-vision optical sight. Located above the image-splitting plane of the beam splitter is a microdisplay unit, such as an OLED (organic light-emitting diode) display, e.g., MT7DMQWV3A micro display (product of Micron Technology, Inc.). This display unit has 300×224 full-color pixels (201,000 effective dots). Fast-switching ferroelectric liquid crystal (FLC) material eliminates motion smearing. The hexagonal pixel shape with ½-pixel offset effectively doubles perceived horizontal resolution and smooths diagonal line appearance. The display is characterized by low power: 85 mW including LED illumination and display driver during typical operation. The display is provided with an electronic display support unit that allows adjustment of brightness and contrast, positive/negative inversion, and selection of colors.

However, in the optical system of the invention, the OLED display is powered from the power supply system of the attachment and can be activated only when attachment unit is connected to the basic day-vision device. When a viewer observes a target through the optical system of the basic day-vision optical sight without the attachment, he/she sees the target and image of the reticle directly through the optical-sight objective and the beam splitter and without participation of the microdisplay.

The digital optical attachment unit that may comprise a CCD module, a thermovisor, or the like, is a special attachment unit that does not have and does not need an eyepiece. It consists of an attachment objective, a CCD array, a CCD array electronic support, and a power supply unit, e.g., a pair of lithium ion batteries CR123.

The digital optical attachment and the day-vision optical sight have mechanical and electrical connection components. Mechanical connection can be carried out through a quick-release connection unit. This unit may be of any type known in the art for connection of various attachments, e.g., one used on conventional day- or night-vision optical sights. An example of a quick-release connection unit is an ATN Quick Release Mount produced by ATN Corp. The device has dual locking levers and a weaver mounting system. The electrical connection components electrically connect the power supply unit of the digital optical attachment with the aforementioned OLED microdisplay for transmission of an image signal from the CCD electronic support unit of the attachment. The electrical connection component also connects the lithium ion batteries with the electronic support unit of the display.

When a viewer observes a target through the optical system of the basic day-vision optical sight with the digital attachment in the activated state, he/she sees the reticle and the target image reflected from the image-splitting plane onto the microdisplay. At the same time, the microdisplay reproduces a fused image of the target obtained through the objective lens of the digital optical attachment.

Thus, when activated, the digital attachment of the optical system of the invention supplies electrical power from the lithium ion batteries to the electronic support unit of the microdisplay and transmit to the display a CCD day-vision or a thermovision image of the target fused with the target and reticle images reflected though the beam splitter to the display from the optical system of the main day-vision optical sight. If necessary, the CCD attachment can be quickly disconnected, and the basic day-vision optical sight can be used independently. The attachable CCD or thermo-module does not have an eyepiece and therefore is small and lightweight. Consequently, it is convenient for storage, e.g., in a user's pocket, and when necessary can be quickly connected mechanically and electrically to the basic day-vision optical sight.

### BRIEF DESCRIPTION OF THE DRAWINGS

FIG. 1 is a block diagram of the optical system of the invention.

FIG. 2 is a longitudinal sectional layout of system components.

### DETAILED DESCRIPTION OF THE INVENTION

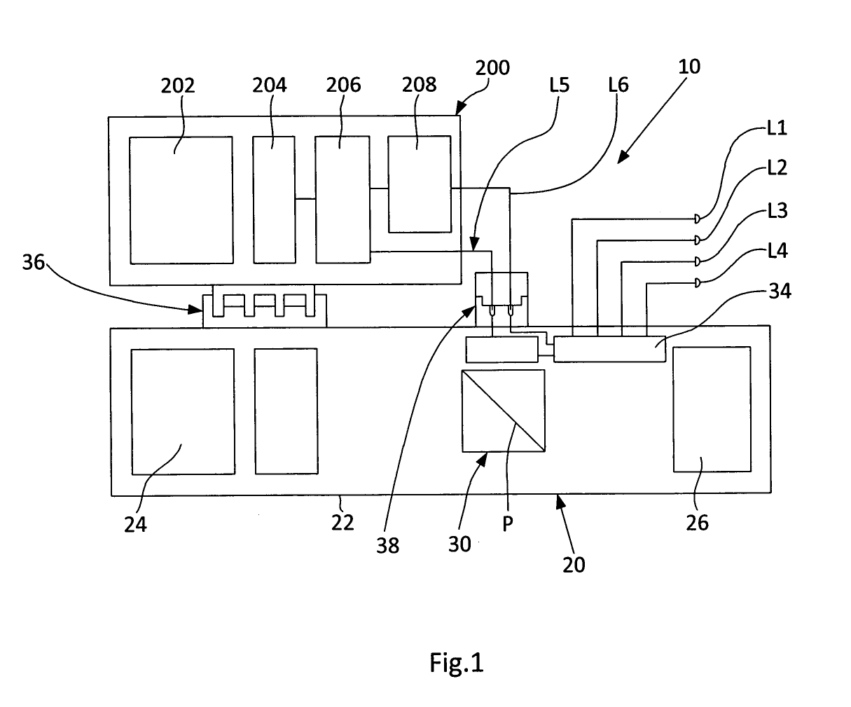

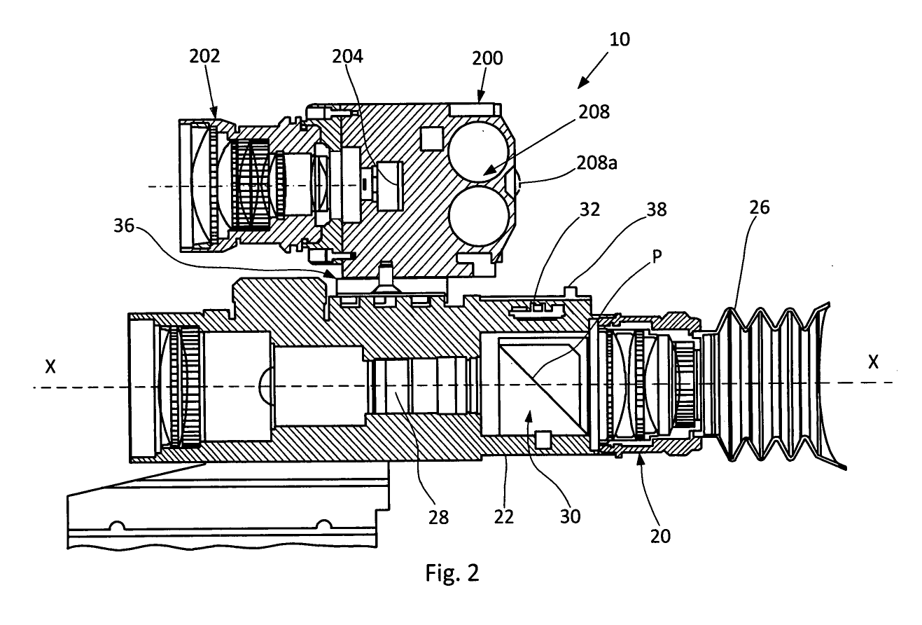

The invention provides an optical system with automatic fusion of attachment images with images of a basic day-vision optical sight. FIG. 1 is a block diagram of the optical system of the invention, and FIG. 2 is a longitudinal sectional layout of system components.

As can be seen from the drawings, the system, which as a whole is designated by reference numeral 10, consists of a basic day-vision optical unit 20, e.g., a day-vision optical sight, a spotting scope, a binocular, or the like, and a digital optical attachment unit 200 such as a CCD module, thermovisor, or range finder. In FIGS. 1 and 2, for illustrative purposes only, the basic day-vision optical unit 20 is shown as a day-vision optical sight intended for installation on a weapon.

The basic day-vision optical sight 20 comprises a housing 22 that contains an objective lens 24 on one end and an eyepiece 26 on the other end, a Pechan prism 28 with a reticle (not shown), and a beam-splitter prism 30 located inside the housing 22 on the optical axis X-X of the day-vision optical sight 20 between the objective lens 24 and the eyepiece 26.

In the system 10 of the invention, the basic day-vision optical sight 20 does not need and does not have a power supply since, as described below, power is provided from the digital optical attachment unit 200 when the unit is mechanically attached to the basic day-vision optical sight 20 and is electrically connected to respective components of the sight 20.

Located above the image-splitting plane P of the beam splitter 30 is an electronic microdisplay unit 32, such as an OLED (organic light-emitting diode) display, e.g., MT7DMQWV3A microdisplay (product of Micron Technology, Inc.). This display unit has 300×224 full-color pixels (201,000 effective dots). Fast-switching ferroelectric liquid crystal (FLC) material eliminates motion smearing. A hexagonal pixel shape with ½-pixel offset effectively doubles perceived horizontal resolution and smooths diagonal line appearance. The display is characterized by low power: 85 mW including LED illumination and display driver during typical operation. The display 32 is provided with an electronic microdisplay support unit 34 (FIG. 1) that allows adjustment of brightness (L1), contrast (L2), positive/negative inversion (L3), selection of colors (L4), etc.

However, in the optical system of the invention, the OLED display 32 is powered from the power supply system of the attachment 200 and can be activated only when the attachment unit is electrically connected to the basic day-vision sight 20. When a viewer observes a target through the optical system of the basic day-vision optical sight 20 without the attachment 200, he/she sees the target and image of the reticle directly through the optical-sight objective 24 and the beam splitter 30 but without participation of the microdisplay 32.

The digital optical attachment unit 200 that may comprise a CCD module, a thermovisor, or the like is a special attachment unit that does not have and does not need an eyepiece. It consists of an attachment objective 202, a CCD array 204, a CCD array electronic support 206 (FIG. 1), and a power supply unit 208, e.g., a pair of lithium ion batteries CR123.

The digital optical attachment 200 and the day-vision optical sight 20 have mechanical and electrical connection components. Mechanical connection can be carried out through a quick-release connection unit 36. This unit may be of any type known in the art for connection of various attachments, e.g., one used on conventional day- or night-vision optical sights. An example of a quick-release connection unit is an ATN Quick Release Mount produced by ATN Corp. The device has dual locking levers and a weaver mounting system.

An electrical connection unit 38 (FIG. 1) electrically connects the power supply unit 208 of the digital optical attachment 200 with the aforementioned OLED microdisplay (wire line L5) for transmission of an image signal from the CCD electronic support unit 206 of the attachment 200. The electrical connection unit 38 also connects the lithium ion batteries 208 with the electronic support unit 34 of the display (wire line L6). In FIG. 2, reference numeral 208a designates the ON/OFF switch of the lithium ion batteries 208.

Thus, when activated, the digital attachment 200 of the optical system 10 of the invention supplies electrical power from the lithium ion batteries 208 to the electronic support unit 34 of the microdisplay 32 and transmits to the display 32 a CCD day-vision or thermovision image of the target. At the same time the target and reticle images obtained through the main day-vision sight 20 are reflected to the microdisplay 32 from the beam splitter 30. As a result, a viewer who observes the images through the eyepiece 26 of the basic day-vision optical sight 20 sees an enhanced fused image composed of image components of the main day-vision sight 20 and of the digital optical attachment 200 on the screen of the microdisplay 32.

If necessary, the CCD attachment 200 can be quickly disconnected, and the basic day-vision optical sight 20 can be used independently. Since the attachable CCD or thermo-module 200 does not have an eyepiece, it is small and lightweight. Therefore, it is convenient for storage, e.g., in a user's pocket, and when necessary can be quickly connected mechanically and electrically to the basic day-vision optical sight 20.

Although the invention is shown and described with reference to specific embodiments, it is understood that these embodiments should not be construed as limiting the areas of application of the invention and that any changes and modifications are possible provided that these changes and modifications do not depart from the scope of the attached patent claims. For example, as mentioned above, the main day-vision sight may comprise various optical devices such as spotting scopes and binoculars.

1. An optical system comprising:
a digital optical attachment unit that comprises an attachment objective lens, a CCD array, a CCD array electronic support, and a power supply unit; and
a basic day-vision optical device that has an optical axis and comprises a housing; an objective lens on one end of the housing; an eyepiece on the other end of the housing; a Pechan prism with a reticle; a beam-splitter prism located inside the housing on the optical axis X-X of the day-vision optical device between the objective lens and the eyepiece; an electronic microdisplay unit; and an electronic microdisplay support unit;
a device for mechanically connecting the digital optical attachment unit to the basic day-vision optical device; and
an electrical connection unit that has means for electrically connecting the power supply unit of the digital optical attachment to the electronic microdisplay support unit and for electrically connecting the electronic microdisplay to the CCD array electronic support.

2. The optical system of claim 1, wherein the basic day-vision optical device is selected from the group consisting of a day-vision optical sight, a spotting scope, and a binocular.

3. The optical system of claim 2, wherein the digital optical attachment unit is selected from the group consisting of a CCD module, a thermovisor, and a range finder.

4. The optical system of claim 1, wherein the electronic microdisplay is an OLED microdisplay.

5. The optical system of claim 2, wherein the electronic microdisplay is an OLED microdisplay.

6. The optical system of claim 3, wherein the electronic microdisplay is an OLED microdisplay.

7. The optical system of claim 1, wherein the power supply unit comprises a lithium ion battery.

8. The optical system of claim 3, wherein the power supply unit comprises a lithium ion battery.

9. The optical system of claim 6, wherein the power supply unit comprises a lithium ion battery.

10. The optical system of claim 1, wherein the device for mechanically connecting the digital optical attachment unit to the basic day-vision optical device is a quick-release connection unit.

11. The optical system of claim 2, wherein the device for mechanically connecting the digital optical attachment unit to the basic day-vision optical device is a quick-release connection unit.

12. The optical system of claim 3, wherein the device for mechanically connecting the digital optical attachment unit to the basic day-vision optical device is a quick-release connection unit.

13. The optical system of claim 8, wherein the device for mechanically connecting the digital optical attachment unit to the basic day-vision optical device is a quick-release connection unit.

14. The optical system of claim 9, wherein the device for mechanically connecting the digital optical attachment unit to the basic day-vision optical device is a quick-release connection unit.
